(19) United States
(12) Patent Application Publication
(10) Pub. No.: US 2017/0225980 A1
(43) Pub. Date: Aug. 10, 2017

(54) Dosing Assembly for Chemical Treatment Systems and Methods of Controlling the Same

(71) Applicant: Process Solutions, Inc., Campbell, CA (US)

(72) Inventors: Brent A. Simmons, Palo Alto, CA (US); James Curtis Robertson, San Jose, CA (US)

(21) Appl. No.: 15/424,127

(22) Filed: Feb. 3, 2017

Related U.S. Application Data
(60) Provisional application No. 62/291,950, filed on Feb. 5, 2016.

(51) Int. Cl. C02F 1/68; C02F 1/50

(52) U.S. Cl. CPC C02F 1/685; C02F 1/50; C02F 2209/40; C02F 2209/03; C02F 2303/04

(57) ABSTRACT

A dosing assembly comprising: a water sample inlet; a water sample outlet; a chemical analyzer in fluid communication with the water sample inlet and outlet; a chemical injector comprising a hollow body having an inlet and an outlet; and a motive flow line comprising a hollow body having a water inlet, a fluid outlet, and a chemical inlet positioned between the water inlet and fluid outlet, wherein the outlet of the chemical injector is connected to the chemical inlet of the motive flow line. A treatment delivery system is also disclosed.

### CROSS REFERENCE TO RELATED APPLICATIONS

This application claims the benefit of U.S. Provisional Application No. 62/291,950 filed Feb. 5, 2016, which is incorporated herein by reference in its entirety.

### BACKGROUND OF THE INVENTION

Field of the Invention

The present invention relates to a dosing assembly for treatment delivery systems and methods of controlling the same.

Description of Related Art

Water utilities add disinfectants to water systems to prevent contamination from germs and bacteria such as Salmonella. These disinfectants typically include chlorine and/or chloramines. For instance, hypochlorite and ammonia can be introduced into a water system to produce monochloramine. Considerable efforts have been expended in developing chemical treatment systems that introduce disinfectants into water systems to prevent contamination. While these chemical treatment systems effectively distribute disinfectants, there are still various drawbacks associated with controlling and monitoring the dosing of disinfectants into a system especially in non-automated systems.

Thus, it is desirable to provide an improved dosing assembly for chemical treatment systems, as well as improved methods for controlling a dosing assembly for chemical treatment systems. It is further desirable to provide a dosing assembly that can accurately control and monitor the distribution of disinfectants into a water system.

### SUMMARY OF THE INVENTION

According to one preferred and non-limiting embodiment or aspect, provided is a dosing assembly comprising: a water sample inlet; a water sample outlet; a chemical analyzer in fluid communication with the water sample inlet and outlet; a chemical injector comprising a hollow body having an inlet and an outlet; and a motive flow line comprising a hollow body having a water inlet, a fluid outlet, and a chemical inlet positioned between the water inlet and fluid outlet, wherein the outlet of the chemical injector is connected to the chemical inlet of the motive flow line.

In one preferred and non-limiting embodiment or aspect, the motive flow line further comprises a water control nozzle, a flow meter, and a pressure gauge. Further, in one preferred and non-limiting embodiment or aspect, the dosing assembly further comprises a pumping device connected to the water sample inlet. The dosing assembly, in one preferred and non-limiting embodiment or aspect, also comprises an electronic display configured to display a concentration of chemical contents of a water sample. A chemical flow nozzle can further be positioned at the inlet or outlet of the chemical injector.

In one preferred and non-limiting embodiment or aspect, the dosing assembly is arranged on a panel. The dosing assembly arranged on the panel can also be at least partially encased by an enclosure.

According to one preferred and non-limiting embodiment or aspect, provided is a treatment delivery system comprising: a dosing assembly as previously described; and a chemical distribution assembly comprising a water motive tube in fluid communication with a water source and a chemical treatment flow tube in fluid communication with the motive flow line of the dosing assembly.

In one preferred and non-limiting embodiment or aspect, the system further comprises a water sampling assembly in fluid communication with the water sample inlet of the dosing assembly. The chemical distribution assembly can also be at least partially submerged in a body of water. In one preferred and non-limiting embodiment or aspect, the water motive tube is positioned below a chemical release point of the chemical treatment flow tube to circulate chemicals into the body of water.

Moreover, in one preferred and non-limiting embodiment or aspect, the motive flow line of the dosing assembly further comprises a water control nozzle, a flow meter, and a pressure gauge. The dosing assembly can also comprise a pumping device connected to the water sample inlet as well as an electronic display configured to display a concentration of chemical contents of a water sample.

In one preferred and non-limiting embodiment or aspect, the dosing assembly further comprises a chemical flow nozzle positioned at the inlet or outlet of the chemical injector. The chemical flow nozzle and water control nozzle of the dosing assembly are configured to adjust the flow rate and amount of chemicals distributed to the chemical treatment flow tube of the chemical distribution assembly.

As previously described, in one preferred and non-limiting embodiment or aspect, the dosing assembly is arranged on a panel. In such embodiment or aspects, the dosing assembly can be at least partially encased by an enclosure.

In one preferred and non-limiting embodiment or aspect, the treatment delivery system further comprises a chemical storage tank in fluid communication with the chemical injector. In addition, the treatment delivery system can also comprise a controller in operable communication with one or more computer-readable storage mediums, that, when executed, cause the controller to control the distribution of chemicals from the dosing assembly to the chemical distribution assembly.

Further preferred and non-limiting embodiment or aspects are set forth in the following numbered clauses.

Clause 1: A dosing assembly comprising: a water sample inlet; a water sample outlet; a chemical analyzer in fluid communication with the water sample inlet and outlet; a chemical injector comprising a hollow body having an inlet and an outlet; and a motive flow line comprising a hollow body having a water inlet, a fluid outlet, and a chemical inlet positioned between the water inlet and fluid outlet, wherein the outlet of the chemical injector is connected to the chemical inlet of the motive flow line.

Clause 2: The dosing assembly according to clause 1, wherein the motive flow line further comprises a water control nozzle, a flow meter, and a pressure gauge.

Clause 3: The dosing assembly according to clause 1 or 2, further comprising a pumping device connected to the water sample inlet line.

Clause 4: The dosing assembly according to any of clauses 1-3, further comprising an electronic display configured to display a concentration of chemical contents of a water sample.

Clause 5: The dosing assembly according to any of clauses 1-4, further comprising a chemical flow nozzle positioned at the inlet or outlet of the chemical injector.

Clause 6: The dosing assembly according to any of clauses 1-5, wherein the dosing assembly is arranged on a panel.

Clause 7: The dosing assembly according to clause 6, wherein the dosing assembly is at least partially encased by an enclosure.

Clause 8: A treatment delivery system comprising: a dosing assembly according to any of clauses 1-7; and a chemical distribution assembly comprising a water motive tube in fluid communication with a water source and a chemical treatment flow tube in fluid communication with the motive flow line of the dosing assembly.

Clause 9: The treatment delivery system according to clause 8, further comprising a water sampling assembly in fluid communication with the water sample inlet of the dosing assembly.

Clause 10: The treatment delivery system according to any of clauses 8 and 9, wherein the chemical distribution assembly is at least partially submerged in a body of water.

Clause 11: The treatment delivery system according to any of clauses 8-10, wherein the water motive tube is positioned below a chemical release point of the chemical treatment flow tube to circulate chemicals into the body of water.

Clause 12: The treatment delivery system according to any of clauses 8-11, wherein the motive flow line of the dosing assembly further comprises a water control nozzle, a flow meter, and a pressure gauge.

Clause 13: The treatment delivery system according to any of clauses 8-12, wherein the dosing assembly further comprises a pumping device connected to the water sample inlet.

Clause 14: The treatment delivery system according to any of clauses 8-13, wherein the dosing assembly further comprises an electronic display configured to display a concentration of chemical contents of a water sample.

Clause 15: The treatment delivery system according to any of clauses 8-14, wherein the dosing assembly further comprises a chemical flow nozzle positioned at the inlet or outlet of the chemical injector, and wherein the chemical flow nozzle and water control nozzle of the dosing assembly are configured to adjust the flow rate and amount of chemicals distributed to the chemical treatment flow tube of the chemical distribution assembly.

Clause 16: The treatment delivery system according to any of clauses 8-15, wherein the dosing assembly is arranged on a panel.

Clause 17: The treatment delivery system according to clause 16, wherein the dosing assembly is at least partially encased by an enclosure.

Clause 18: The treatment delivery system according to any of clauses 8-17, further comprising a chemical storage tank in fluid communication with the chemical injector.

Clause 19: The treatment delivery system according to any of clauses 8-18, further comprising a controller in operable communication with one or more computer-readable storage mediums that, when executed, cause the controller to control the distribution of chemicals from the dosing assembly and to the chemical distribution assembly.

These and other features and characteristics of the present invention, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and the claims, the singular form of “a”, “an”, and “the” include plural referents unless the context clearly dictates otherwise. Preferred features will be elucidated in the claims and in the specific description of the embodiment or aspects that follow. It will be readily appreciated that preferred features of certain aspects or embodiment or aspects could be usefully incorporated in other described embodiment or aspects even if not specifically described in those terms herein.

### BRIEF DESCRIPTION OF THE DRAWINGS

FIG. 1 is a schematic view of one embodiment or aspect of a dosing assembly according to the principles of the present invention;

FIG. 2 is a front view of an enclosure for the dosing assembly of FIG. 1;

FIG. 3 is a side view of the enclosure of FIG. 2;

FIG. 4 is a cross-sectional side view of the enclosure of FIG. 2;

FIG. 5 is a schematic view of one embodiment or aspect of a treatment delivery system according to the principles of the present invention;

FIG. 6 is a schematic view of one embodiment or aspect of a chemical distribution assembly according to the principles of the present invention; and

FIG. 7 is a flow and control diagram of one embodiment or aspect of a treatment delivery system according to the principles of the present invention.

### DETAILED DESCRIPTION OF THE INVENTION

For purposes of the following detailed description, it is to be understood that the invention may assume various alternative variations and step sequences, except where expressly specified to the contrary. Moreover, other than in any operating examples, or where otherwise indicated, all numbers expressing, for example, quantities of ingredients used in the specification and claims are to be understood as being modified in all instances by the term “about”. Accordingly, unless indicated to the contrary, the numerical parameters set forth in the following specification and attached claims are approximations that may vary depending upon the desired properties to be obtained by the present invention. At the very least, and not as an attempt to limit the application of the doctrine of equivalents to the scope of the claims, each numerical parameter should at least be construed in light of the number of reported significant digits and by applying ordinary rounding techniques.

Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard variation found in their respective testing measurements.

Also, it should be understood that any numerical range recited herein is intended to include all sub-ranges subsumed therein. For example, a range of “1 to 10” is intended to include all sub-ranges between (and including) the recited minimum value of 1 and the recited maximum value of 10, that is, having a minimum value equal to or greater than 1 and a maximum value of equal to or less than 10.

Further, the terms “upper,” “lower,” “right,” “left,” “vertical,” “horizontal,” “top,” “bottom,” “lateral,” “longitudinal,” and derivatives thereof shall relate to the invention as it is oriented in the drawing figures. However, it is to be understood that the invention may assume alternative variations and step sequences, except where expressly specified to the contrary. It is also to be understood that the specific devices and processes illustrated in the attached drawings, and described in the specification, are simply exemplary embodiment or aspects of the invention. Hence, specific dimensions and other physical characteristics related to the embodiment or aspects disclosed herein are not to be considered as limiting.

In this application, the use of the singular includes the plural and plural encompasses singular, unless specifically stated otherwise. In addition, in this application, the use of “or” means “and/or” unless specifically stated otherwise, even though “and/or” may be explicitly used in certain instances.

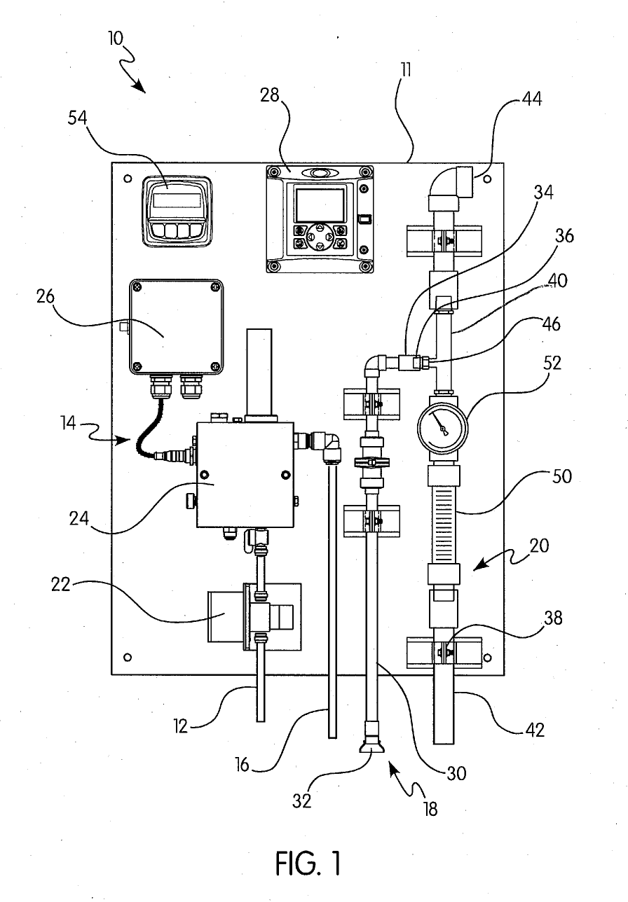

As indicated, the present invention is directed to a dosing assembly 10 that is used to control and monitor the distribution of disinfectants into a body of water. Referring to FIGS. 1, and in one preferred and non-limiting embodiment or aspect, the dosing assembly 10 includes, but is not limited to, a water sample inlet 12, a chemical analyzer 14, a water sample outlet 16, a chemical injector 18, and a motive flow line 20. The various components of the dosing assembly 10 are arranged on a panel 11 as shown in FIG. 1. The panel 11 can be mounted to an outer surface of a water containment device or any other desired surface that an operator can access. The panel 11 can be mounted and attached to any desired surface with fasteners, such as screws. As such, the panel 11 can be un-mounted at any time by simply removing the fasteners.

As indicated, and in one preferred and non-limiting embodiment or aspect, the dosing assembly 10 of the present invention can include a water sample inlet 12. As shown in FIG. 1, the water sample inlet 12 is connected to a pumping device 22. A non-limiting example of a suitable pumping device 22 includes a liquid metering pump. The water sample inlet 12 of the dosing assembly 10 can be connected to a water sample transport line that is at least partially submerged in a body of water. The pumping device 22 can draw a water sample through the water sample transport line and into the water sample inlet 12. The pumping device 22 can be configured to draw a precise volume of water into the water sample inlet 12 at a particular flow rate.

As further shown in FIG. 1, and in one preferred and non-limiting embodiment or aspect, the water sample inlet 12 is connected to the chemical analyzer 14. Accordingly, the water sample drawn into the water sample inlet 12 can be transported to the chemical analyzer 14. After receiving a water sample, the chemical analyzer 14 analyzes the contents thereof In one preferred and non-limiting embodiment or aspect, the chemical analyzer 14 is configured to determine the concentration of disinfectants, such as chlorine and chloramine, in the water sample. In some examples, the chemical analyzer 14 is configured to measure the total chlorine in a water sample and, from this measurement, the residual chloramine concentration is determined. The chemical analyzer 14 can include various components that control and analyze an incoming water sample. For example, the chemical analyzer 14 can include, but is not limited to, a water sample flow block 24 and an electronic analyzer 26. A non-limiting chemical analyzer 14 includes a HACH® SC200 flow block and electronic analyzer, commercially available from Hach.

In one preferred and non-limiting embodiment or aspect, the dosing assembly 10 can also include an electronic display 28 for monitoring the concentration of disinfectants obtained from the chemical analyzer 14. For instance, the electronic display 28 can be used to monitor the total chlorine concentration in a water sample. As shown in FIG. 1, the electronic display 28 can be mounted onto the panel 11 for easy access during operation of the dosing assembly 10.

After a water sample has been analyzed, the sample can be transported through a water sample outlet 16 that is connected to the chemical analyzer 14. The water sample outlet 16 can be arranged to distribute the analyzed water sample to any desired location. For example, the water sample outlet 16 can be arranged to distribute the water sample back into the water source or to a sewage drain for disposal.

In one preferred and non-limiting embodiment or aspect, the dosing assembly 10 of the present invention can further include a chemical injector 18. As shown in FIG. 1, the chemical injector 18 comprises a hollow body 30, such as piping and/or tubing having an inlet 32 and an outlet 34. The inlet 32 of the chemical injector 18 is in fluid communication with a chemical storage container such as a carboy, and the outlet 34 of the chemical injector 18 is connected to a motive flow line 20. Further, the flow of chemicals through the chemical injector 18 can be controlled with a chemical flow nozzle 36. The chemical flow nozzle 36 can include, but is not limited to, a venturi nozzle or an eductor. The chemical flow nozzle 36 can be positioned at the inlet 32 or the outlet 34, such as shown in FIG. 1, of the chemical injector 18.

As indicated, and on one preferred and non-limiting embodiment or aspect, the dosing assembly 10 can include a motive flow line 20 that is in fluid communication with the chemical injector 18. Referring to FIG. 1, the motive flow line 20 includes a water control nozzle 38 and a hollow body 40, such as piping and/or tubing, having a water inlet 42 at one end and a fluid outlet 44 at an opposite end. As further shown in FIG. 1, the motive flow line 20 also includes a chemical inlet 46 positioned between the water inlet 42 and the fluid outlet 44. The chemical inlet 46 is connected to the outlet 34 of the chemical injector 18, and the water inlet 42 is in fluid communication with a water source that provides motive flow into the hollow body 40 of the motive flow line 20. As used herein, “motive flow” refers to a flow of fluid at high pressures. A flow meter 50 and a pressure gauge 52 can be incorporated into the motive flow line 20 for measuring and monitoring the pressure and flow rate of water flowing into the motive flow line 20.

In one preferred and non-limiting embodiment or aspect, the dosing assembly 10 can also include additional components for controlling and monitoring the distribution of disinfectants into a body of water. For example, and as shown in FIG. 1, the dosing assembly 10 can include a flow meter display 54 that displays the flow rate of fluids through the motive flow line 20.

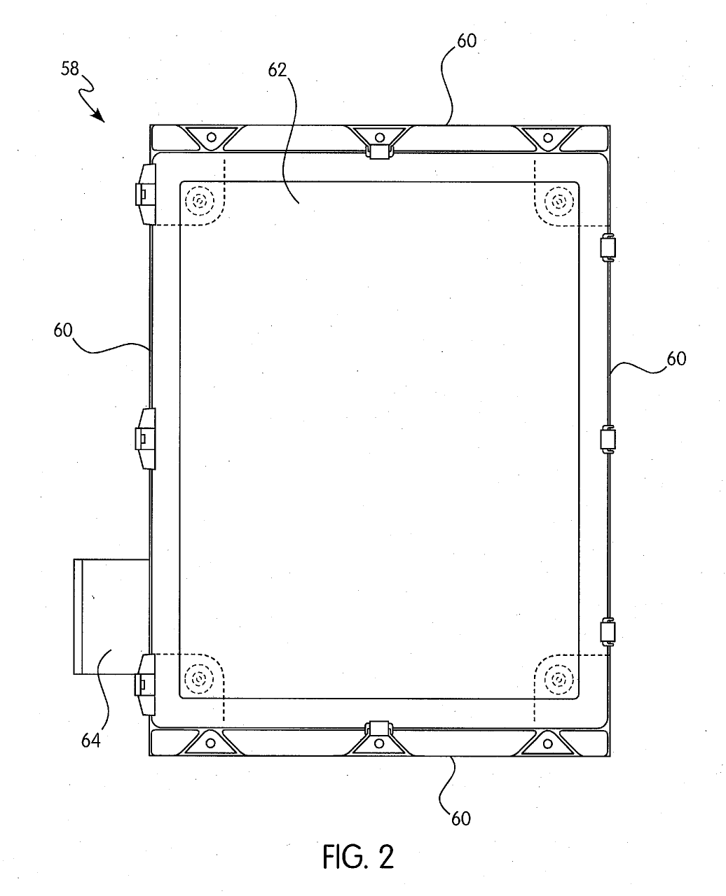

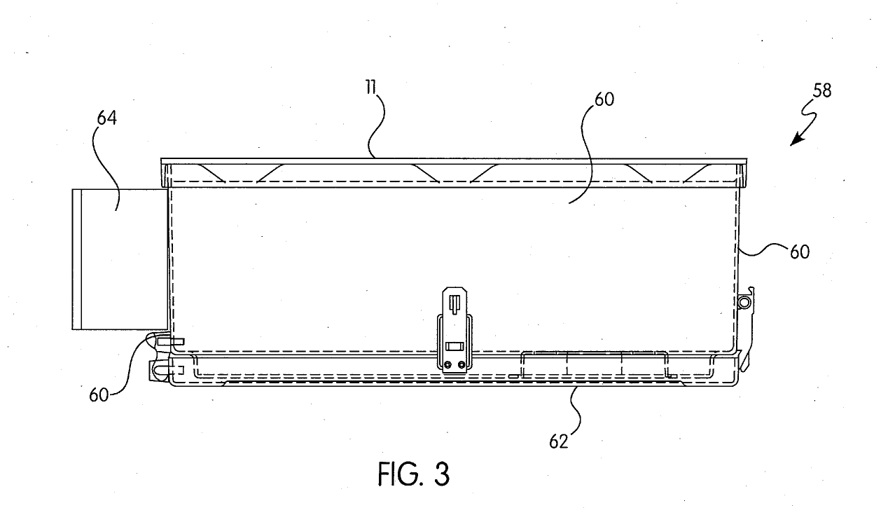

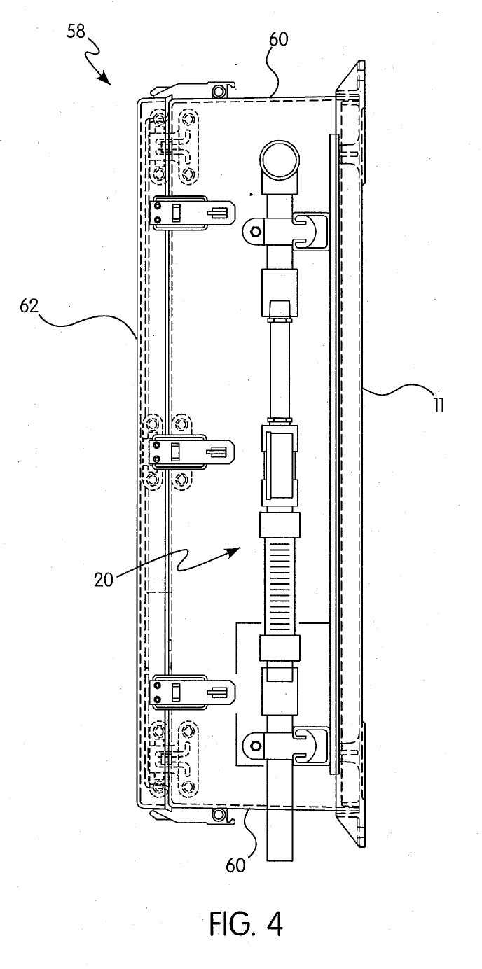

In one preferred and non-limiting embodiment or aspect, the various components of the dosing assembly 10 are arranged on a panel 11 that can be detachably mounted to any desired surface. As shown in FIGS. 2-4, the dosing assembly 10 arranged on the panel 11 can be encased by an enclosure 58 comprising a plurality of walls 60 and a door 62 that protects the components of the dosing assembly 10 from physical and environmental damage. The walls 60 can include holes where a portion of the water sample inlet 12, water sample outlet 16, chemical injector 18, and/or motive flow line 20 can extend out from the enclosure 58. Further, at least one of the walls can also include a hole for a power supply line 64 that provides power to the various components of the dosing assembly 10.

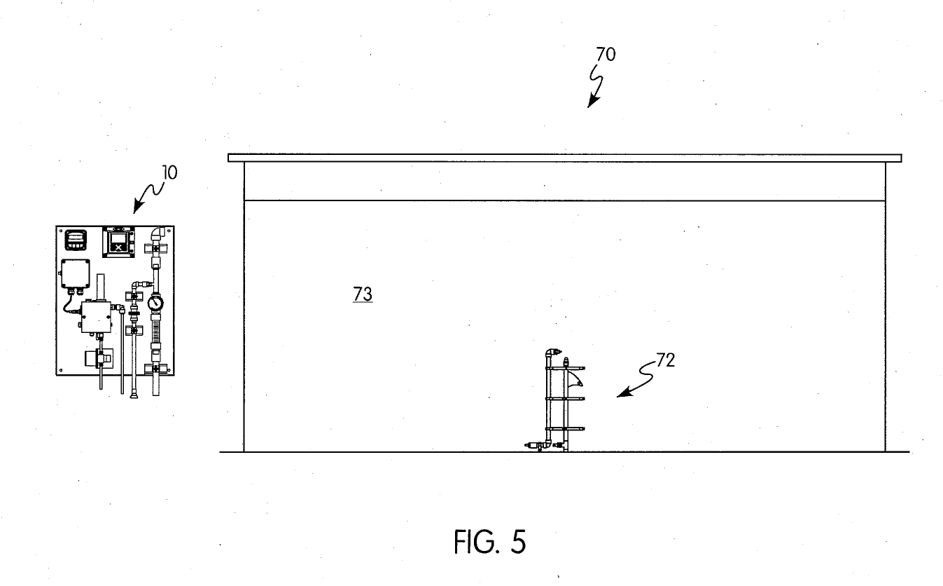

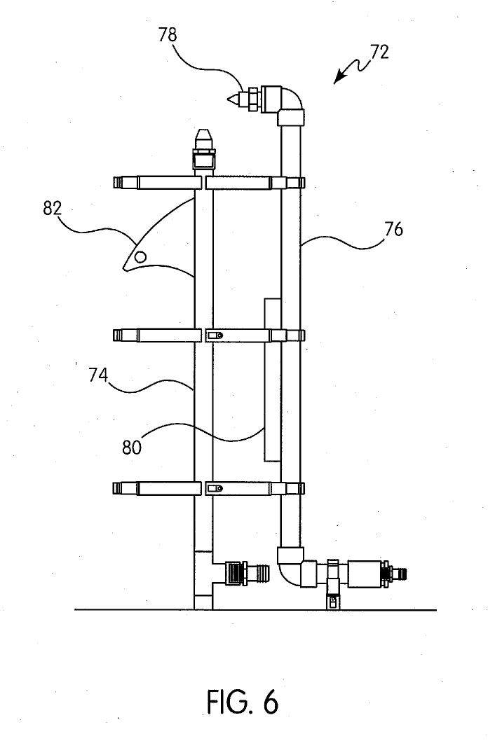

As shown in FIG. 5, and in one preferred and non-limiting embodiment or aspect, the present invention is also directed to a treatment delivery system 70. The treatment delivery system 70 includes the previously described dosing assembly 10 and a chemical distribution assembly 72 that can be at least partially submerged in a body of water 73. Referring to FIG. 6, the chemical distribution assembly 72 can include a water motive tube 74 and a chemical treatment flow tube 76. The water motive tube 74 and chemical treatment tube 76 of the chemical distribution assembly 72 can be oriented to expel water and chemicals, respectively, into the body of water 73. In addition, the water motive tube 74 is positioned below the release point such as a nozzle 78 of the chemical treatment flow tube 76 to circulate the chemicals into the body of water 73. The flow of water out of the water motive tube 74 can also create a high energy, high velocity mixing zone directly above the water motive tube 74 where the chemicals can be released, which helps chemicals interact and form a particular compound such as monochloramine. The chemical distribution assembly 72 can also include a cable guide 82 that can be used to retrieve the chemical distribution assembly 72 from a body of water 73 with cables such as stainless steel cables and chains.

In one preferred and non-limiting embodiment or aspect, the treatment delivery system 70 can further include a water sampling assembly 80 that is configured to extract water samples from the body of water 73. As shown in FIG. 6, the water sampling line 80 can be a component of the chemical distribution assembly 72. For example, the water motive tube 74, chemical treatment tube 76, and water sampling assembly 80 of the chemical distribution assembly 72 can be secured to a frame that is adapted to rest at the bottom of a reservoir. Alternatively, the water motive tube 74, the chemical treatment tube 76, and the water sampling assembly 80 can extend into the reservoir to a desired depth. Yet another alternative is that the water sampling assembly 80 can be separate from the chemical distribution assembly 72 and may be located near the top of the reservoir.

In one preferred and non-limiting embodiment or aspect, the chemical treatment flow tube 76 is in fluid communication with the motive flow line 20 of the dosing assembly 10. Thus, during operation of the treatment delivery system 72, the chemical flow nozzle 36 and water control nozzle 38 of the dosing assembly 10 can be used to adjust the flow rate and amount of chemicals distributed to the chemical treatment flow tube 76 of the chemical distribution assembly 72. Further, the flow meter 50 and pressure gauge 52 can be used to monitor the flow rate and determine whether the rate needs to be adjusted. As such, the dosing assembly 10 can be used to control and monitor the flow of chemicals to the chemical distribution assembly 72 during operation of the treatment delivery system 70.

In addition, and in one preferred and non-limiting embodiment or, aspect, the water sampling assembly 80 is in fluid communication with the water sample inlet 12 of the dosing assembly 10. As such, during operation of the treatment delivery system 70, a water sample is obtained with the water sampling assembly 76 and transported to the water sample inlet 12 of the dosing assembly 10. The water sample is then transferred to the chemical analyzer 14 where the concentration of disinfectants in the body of water 73 is determined. As previously described, the disinfectant concentration obtained from the chemical analyzer 14 can be monitored with an electronic display 28. Based on this information, an operator can determine whether the flow rate and amount of chemicals distributed to the chemical treatment flow tube 76 should be maintained or adjusted.

In one preferred and non-limiting embodiment or aspect, the treatment delivery system 70 can further include one or more chemical storage tanks that contain different types of chemicals. The inlet 32 of the chemical injector 18 can be fluidly attached to one of the chemical storage tanks to transport a particular chemical. In order to distribute different types of chemicals to the chemical treatment flow tube 76, the chemical injector 18 can be fluidly connected to different chemical storage tanks at different time periods. For example, the chemical injector 18 can be fluidly connected to a first chemical storage tank that contains ammonia. After ammonia is distributed into the body of water 73, the chemical injector 18 can be fluidly connected to a second chemical storage tank that contains hypochlorite. The chemical treatment flow tube 76 can then distribute hypochlorite into the body of water 73 that already contains ammonia. As would be recognized by one skilled in the art, this process can be used to generate monochloramine.

Further details of chemical distribution assemblies that can be used with the present invention are disclosed in U.S. Pat. No. 9,039,902, which is incorporated by reference herein in its entirety. For example, the chemical distribution assembly can include the assembly described in column 12 line 13 to column 13 line 41 and FIG. 11 or 12 of U.S. Pat. No. 9,039,902.

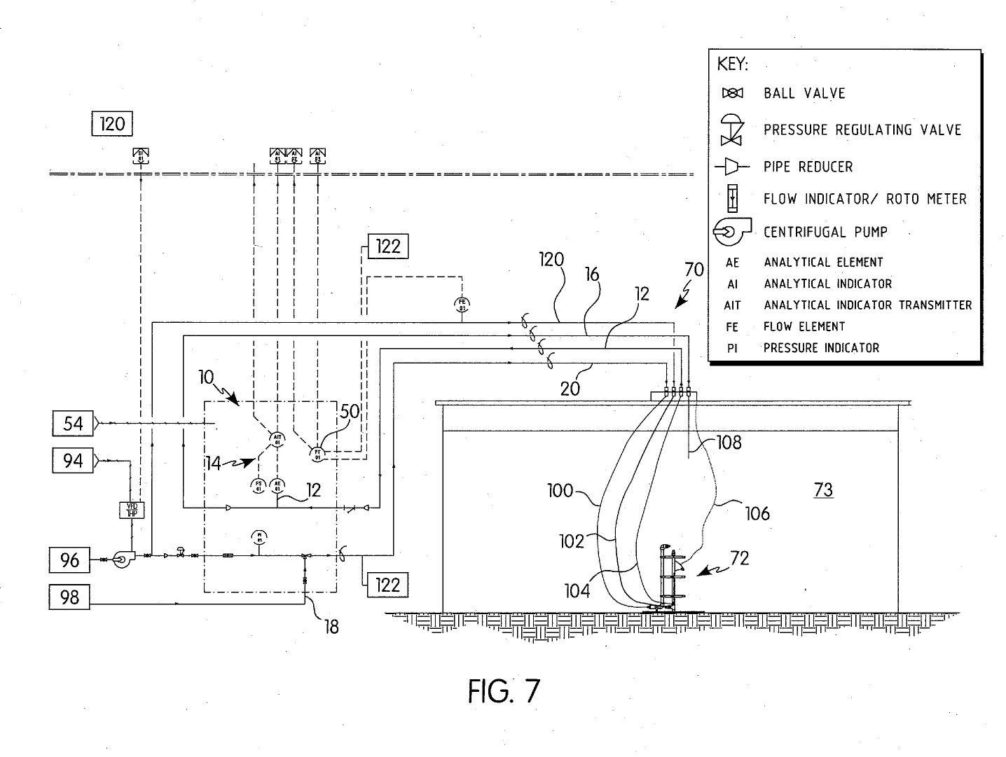

FIG. 7 illustrates a flow and control diagram of a treatment delivery system 70. As shown in FIG. 7, the treatment delivery system 70 includes a dosing assembly 10 as previously described comprising a water sample inlet 12, a chemical analyzer 14, a water sample outlet 16, a chemical injector 18, and a motive flow line 20. A flow meter 50 and a flow meter display 54 are used to determine the flow rate of fluids through the motive flow line 20. A water source 96 is in fluid communication with the motive flow line 20, and a chemical storage container 98 is in fluid communication with the chemical injector 18. The water source 96 is also in fluid communication with a direct motive flow line 120 that provides motive water flow directly to the water motive tube 74. In addition, a power supply 94 is used to control the system 70.

As further shown in FIG. 7, a chemical distribution assembly 72 as previously described is submerged in a body of water 73. The chemical distribution assembly 72 is in fluid communication with the dosing assembly 10 through a water sample transport line 104 and a chemical injector transport line 100. A sample transport outlet line 108 is also used to distribute a previously analyzed water sample directly back into the body of water 73. Further, a motive water transport return line 102 connects the water source 96 to the chemical distribution assembly 72. A cable guide 82 is also attached to a cable 106 so that the chemical distribution assembly 72 can be retrieved from the body of water 73.

During operation of the treatment delivery system 70 and as illustrated in FIG. 7, a water sample is obtained from the chemical distribution assembly 72 and transferred to the water sample inlet 12 through the water sample transport line 104. The water sample is then transferred to the chemical analyzer 14 where the chemical contents are determined. After analysis, the water sample is transferred back into the body of water 73 through the water sample outlet 16 and the sample transport outlet line 108. Chemical(s) and motive water flow are also delivered into the body of water 73 as previously described with the chemical distribution assembly 72. Particularly, chemical(s) can be transported from the chemical storage container 98, through the chemical injector 18, into the motive flow line 20, through the chemical injector transport line 100, and into the body of water 73 with the chemical distribution assembly 72. Further, motive water flow is supplied directly to the water motive tube 74 of the chemical distribution assembly 72 through a direct motive flow line 120.

It is appreciated that the treatment delivery system 70 can include one chemical distribution assembly 72 as well as additional chemical distribution assemblies 122 such as two or more multiple chemical distribution assemblies 72 and 122. In such embodiment or aspects, the treatment delivery system 70 can include one dosing assembly 10 or multiple dosing assemblies 10 such as two or more dosing assemblies 10. When multiple dosing assemblies 10 are used with multiple chemical distribution assemblies 72 and 122, each chemical distribution assembly 72 and 122 can be associated with a separate dosing assembly 10.

The dosing assembly 10 and the chemical distribution assembly 72 can also be controlled by a controller 120 in operable communication with one or more computer-readable storage mediums. The computer-readable storage mediums can contain programming instructions that, when executed, cause the controller 120 to perform multiple tasks. This includes programming algorithms that allow the controller 120 to control the administration of chemicals into the body of water 73. The controller 120 may include one or more microprocessors, CPUs, and/or other computing devices. It is appreciated that the controller 120 can be used to automatically control the treatment delivery system 70 such as by controlling the dosing assembly 10.

Although the invention has been described in detail for the purpose of illustration based on what is currently considered to be the most practical and preferred embodiment or aspects or aspects, it is to be understood that such detail is solely for that purpose and that the invention is not limited to the disclosed embodiment or aspects or aspects, but, on the contrary, is intended to cover modifications and equivalent arrangements that are within the spirit and scope of the appended claims. For example, it is to be understood that the present invention contemplates that, to the extent possible, one or more features of any embodiment or aspect or aspect can be combined with one or more features of any other embodiment or aspect or aspect.

What is claimed is:

1. A dosing assembly comprising:
a water sample inlet;
a water sample outlet;
a chemical analyzer in fluid communication with the water sample inlet and outlet;
a chemical injector having an inlet and an outlet; and
a motive flow line having a water inlet, a fluid outlet, and a chemical inlet positioned between the water inlet and fluid outlet,
wherein the outlet of the chemical injector is connected to the chemical inlet of the motive flow line.

2. The dosing assembly according to claim 1, wherein the motive flow line further comprises a water control nozzle, a flow meter, and a pressure gauge.

3. The dosing assembly according to claim 1, further comprising a pumping device connected to the water sample inlet.

4. The dosing assembly according to claim 1, further comprising an electronic display configured to display a concentration of chemical contents of a water sample.

5. The dosing assembly according to claim 1, further comprising a chemical flow nozzle positioned at the inlet or outlet of the chemical injector.

6. The dosing assembly according to claim 1, wherein the dosing assembly is arranged on a panel.

7. The dosing assembly according to claim 6, wherein the dosing assembly is at least partially encased by an enclosure.

8. A treatment delivery system comprising:
(a) a dosing assembly according to claims 1; and
(b) a chemical distribution assembly comprising a water motive tube in fluid communication with a water source and a chemical treatment flow tube in fluid communication with the motive flow line of the dosing assembly.

9. The treatment delivery system of claim 8, further comprising a water sampling assembly in fluid communication with the water sample inlet of the dosing assembly.

10. The treatment delivery system of claim 8, wherein the chemical distribution assembly is at least partially submerged in a body of water.

11. The treatment delivery system of claim 10, wherein the water motive tube is positioned below a chemical release point of the chemical treatment flow tube to circulate chemicals into the body of water.

12. The treatment delivery system of claim 8, wherein the motive flow line of the dosing assembly further comprises a water control nozzle, a flow meter, and a pressure gauge.

13. The treatment delivery system of claim 8, wherein the dosing assembly further comprises a pumping device connected to the water sample inlet.

14. The treatment delivery system of claim 8, wherein the dosing assembly further comprises an electronic display configured to display a concentration of chemical contents of a water sample.

15. The treatment delivery system of claim 12, wherein the dosing assembly further comprises a chemical flow nozzle positioned at the inlet or outlet of the chemical injector.

16. The treatment delivery system of claim 8, wherein the dosing assembly is arranged on a panel.

17. The treatment delivery system of claim 16, wherein the dosing assembly is at least partially encased by an enclosure.

18. The treatment delivery system of claim 8, further comprising a chemical storage tank in fluid communication with the chemical injector.

19. The treatment delivery system of claim 8, further comprising a controller in operable communication with one or more computer-readable storage mediums that, when executed, cause the controller to control the distribution of chemicals from the dosing assembly to the chemical distribution assembly.
